(19) United States
(12) Patent Application Publication
(10) Pub. No.: US 2017/0188176 A1
(43) Pub. Date: Jun. 29, 2017

(54) SOUND OBJECT CONTROL APPARATUS AND METHOD BASED ON ADDITIONAL IMAGE OBJECT

(71) Applicant: Electronics and Telecommunications Research Institute, Daejeon (KR)

(72) Inventor: Dae Young JANG, Daejeon (KR)

(73) Assignee: Electronics and Telecommunications Research Institute, Daejeon (KR)

(21) Appl. No.: 15/355,610

(22) Filed: Nov. 18, 2016

(30) Foreign Application Priority Data
Nov. 19, 2015 (KR) 10-2015-0162377
Jul. 25, 2016 (KR) 10-2016-0094304

(51) Int. Cl. H04S 7/00; G06F 3/0484

(52) U.S. Cl. CPC H04S 7/40; G06F 3/04842; G06F 3/0481

(57) ABSTRACT

Disclosed is an apparatus and method for controlling a sound object based on an additional image object. A sound object controlling method includes displaying image objects synchronized with a plurality of sound objects, respectively, on a display; and controlling a sound object synchronized with an image object selected by a user from among the image objects displayed on the display. The sound object includes metadata that includes playback location information of the sound object on a specific space, sound level information of the sound object, and display location information of the image object synchronized with the sound object on the display.

### CROSS-REFERENCE TO RELATED APPLICATIONS

This application claims the priority benefit of Korean Patent Application No. 10-2015-0162377 filed on Nov. 19, 2015, and Korean Patent Application No. 10-2016-0094304 filed on Jul. 25, 2016 in the Korean Intellectual Property Office, the disclosures of which are incorporated herein by reference for all purposes.

### BACKGROUND

1. Field

At least one example embodiment relates to an apparatus and method for controlling a sound object based on an additional image object, and more particularly, to an apparatus and method for controlling a sound object synchronized with an image object selected by a user from among image objects synchronized with a plurality of sound objects, respectively, displayed on a display.

2. Description of Related Art

Broadcast contents to which sound object based audio technology is applied are currently on increase. The sound object based audio technology may provide a sense of realism further close to a reality by separating an audio signal for each sound object, and by calculating a playback location of an audio signal for each sound object.

The sound object based audio technology according to the related art provides a method of appropriately playing back a sound object at a playback stage based on a given auditory environment. For example, in a movie field, the sound object based audio technology may calculate and provide a playback location of an audio signal for each sound object based on an image displayed on a display screen, however, may not provide a method that enables a user to directly control each sound object.

Currently, a method of providing a separate graphical user interface (GUI) so that a user directly controls each sound object is provided to solve the above issues. For example, in the case of music, a separate GUI that includes a volume and a switch for each sound object is provided for each track, and a user may control a volume for each sound object, or may turn OFF or turn ON a corresponding sound object.

Alternatively, in the case of a broadcast, a separate GUI that includes a volume and a switch for each sound object included in a broadcast image is provided so that the user may control a volume for each sound object or may turn OFF or turn ON a corresponding sound object. For example, in the case of a broadcast image about a sports game, a commentary sound and a background sound are separated for each object, and the user may adjust a relative sound level of each of the commentary sound and the background sound to be suitable for the taste of the user through a separate GUI.

However, in the related art, a separate GUI is to be provided. In addition, the user may feel inconvenient when the user selects a sound object to be controlled through the provided GUI.

### SUMMARY

At least one example embodiment provides an apparatus and method that enables a user to intuitively control a sound object synchronized with an image object selected by a user from among image objects synchronized with a plurality of sound objects, respectively, displayed on a display.

According to an aspect of at least one example embodiment, there is provided a method of controlling a sound object, the method including displaying image objects synchronized with a plurality of sound objects, respectively, on a display; and controlling a sound object synchronized with an image object selected by a user from among the image objects displayed on the display. The sound object includes metadata that includes playback location information of the sound object on a specific space, sound level information of the sound object, and display location information of the image object synchronized with the sound object on the display.

The displaying may include setting a desired area on the display as an image object for a sound object having no synchronized image object, in response to a presence of the sound object having no synchronized image object among the plurality of sound objects.

The displaying may include recognizing a multichannel speaker having a surround channel disposed on the specific space, in response to a presence of a sound object having no synchronized image object among the plurality of sound objects; setting a virtual auditory space that includes the recognized multichannel speaker; and displaying a virtual image object synchronized with the sound object having no synchronized image object among the plurality of sound objects on the set virtual auditory space.

The image object may be set to be a desire range selectable by a pointing device of the user.

The controlling may include providing an interface for controlling the sound object synchronized with the selected image object, in response to a selection on the desired range by the pointing device of the user; and controlling a location at which the sound object synchronized with the selected image object is to be played back on the specific space and a sound level of the sound object synchronized with the selected image object, according to a manipulation of the user received through the provided interface.

The display location information of the image object synchronized with the sound object on the display may be represented as coordinate information about an absolute horizontal pixel and an absolute vertical pixel of the display.

The display location information of the image object synchronized with the sound object on the display may be represented as horizontal ratio information and vertical ratio information of a relative location of the image object synchronized with the sound object on the display based on a horizontal size and a vertical size of the display.

According to an aspect of at least one example embodiment, there is provided an apparatus for controlling a sound object, the apparatus including a display configured to display image objects synchronized with a plurality of sound objects, respectively; and a processor configured to control a sound object synchronized with an image object selected by a user from among the image objects displayed on the display. The sound object includes metadata that includes playback location information of the sound object on a specific space, sound level information of the sound object, and display location information of the image object synchronized with the sound object on the display.

The processor may be further configured to set a desired area on the display as an image object for a sound object having no synchronized image object, in response to a presence of the sound object having no synchronized image object among the plurality of sound objects.

The processor may be further configured to recognize a multichannel speaker having a surround channel disposed on the specific space, in response to a presence of a sound object having no synchronized image object among the plurality of sound objects, to set a virtual auditory space that includes the recognized multichannel speaker, and to display a virtual image object synchronized with the sound object having no synchronized image object among the plurality of sound objects on the set virtual auditory space.

The image object may be set to be a desire range selectable by a pointing device of the user.

The processor may be further configured to provide an interface for controlling the sound object synchronized with the selected image object, in response to a selection on an image object to be synchronized with each of the plurality of sound objects by the pointing device of the user, and to control a location at which the sound object synchronized with the selected image object is to be played back on the specific space and a sound level of the sound object synchronized with the selected image object, according to a manipulation of the user received through the provided interface.

The display location information of the image object synchronized with the sound object on the display may be represented as coordinate information about an absolute horizontal pixel and an absolute vertical pixel of the display.

The display location information of the image object synchronized with the sound object on the display may be represented as horizontal ratio information and vertical ratio information of a relative location of the image object synchronized with the sound object on the display based on a horizontal size and a vertical size of the display.

According to some example embodiments, a user may intuitively control a sound object by controlling a sound object synchronized with an image object selected by the user from among image objects synchronized with a plurality of sound objects, respectively, displayed on a display.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a sound object control system according to an example embodiment;

FIG. 2 illustrates an example of representing location information of an additional image object according to an example embodiment;

FIG. 3 is a flowchart illustrating a method of controlling a sound object according to an example embodiment;

FIG. 4 illustrates an example of controlling a sound object having no synchronized image object among a plurality of sound objects according to an example embodiment;

FIG. 5 illustrates another example of controlling a sound object having no synchronized image object among a plurality of sound objects according to an example embodiment; and

FIGS. 6A and 6B are graphs showing examples of location information of an additional image object according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The example embodiments will be described with reference to the accompanying drawings. However, the present disclosure is not limited thereto or restricted thereby. Like reference numerals in the drawings refer to like elements throughout.

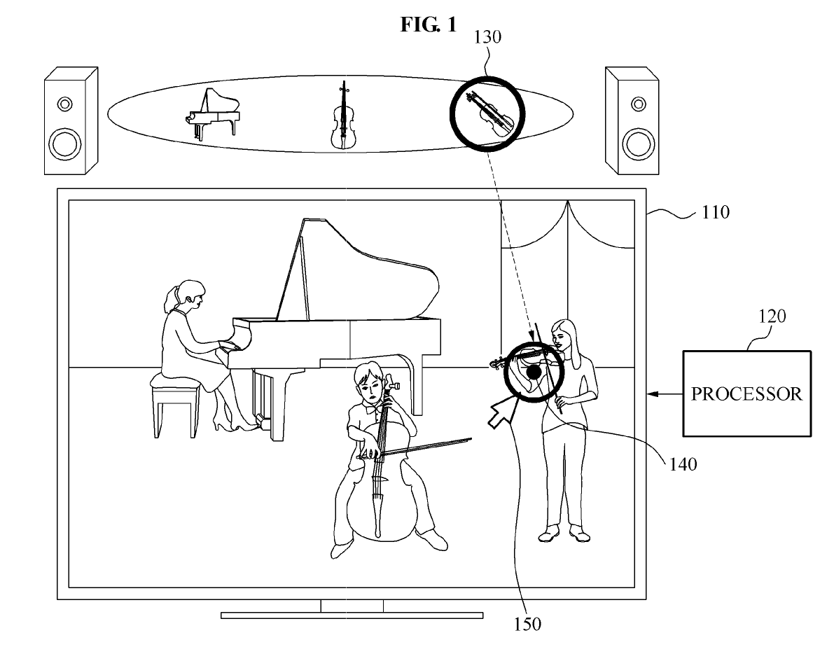

FIG. 1 illustrates a sound object control system according to an example embodiment.

Referring to FIG. 1, the sound object control system may include a display 110 and a processor 120. Additional image objects synchronized with a plurality of sound objects, respectively may be displayed on the display 110. Here, an additional image object displayed on the display 110 may be set to be a desired range selectable by a pointing device 150 of a user.

The processor 120 may display the additional image objects synchronized with the plurality of sound objects, respectively, on the display 110, and may control a sound object synchronized with an additional image object selected by the user from among the additional image objects displayed on the display 110.

In FIG. 1, sound signals corresponding to a plurality of musical instruments, respectively, may be panned and thereby played back between stereo channels. For example, a violin signal may be provided to a violin sound object 130 that includes metadata, and the processor 120 may appropriately render and play back the violin signal on a specific space based on playback location information of the violin sound object 130 included in the metadata.

As described above, a sound object may be created for each of the plurality of musical instruments. The processor 120 may provide a further vivid audio by appropriately rendering and playing back the sound objects on the specific space based on metadata included in each of the sound objects.

Here, the metadata included in the sound object may include playback location information of the sound object on the specific space, sound level information of the sound object, and additional information about display location information of an additional image object synchronized with the sound object on the display 110.

For example, the processor 120 enables interaction between the violin sound object 130 and a violin image object 140 based on display location information of the violin image object 140 synchronized with the violin sound object 130 on the display 110. That is, the user may select the violin image object 140 displayed on the display 110 using the separate pointing device 150. The processor 120 may control the violin sound object 130 to be suitable for the taste of the user through an interface that is provided in correspondence to the selected violin image object 140.

In response to a selection on a specific additional image object on the display 110, the processor 120 may provide information about a sound object synchronized with the selected specific additional image object using a separate popup window. Here, information about the specific sound object provided to the user through the separate popup window may include playback location information of the sound object on the specific space and sound level information of the sound object.

In response to a change in a playback location and a sound level of a sound object synchronized with an additional image object selected through the provided interface, for example, a popup window, the processor 120 may control and play back the corresponding sound object based on the changed playback location and sound level of the sound object.

In response to a presence of a sound object having no synchronized additional image object among the plurality of sound objects, the processor 120 may set and control a desired section on the display 110 as an additional image object for the sound object having no synchronized additional image object. Alternatively, in response to the presence of the sound object having no synchronized additional image object among the plurality of sound objects, the processor 120 may control the sound object having no synchronized additional image object using a virtual additional image object.

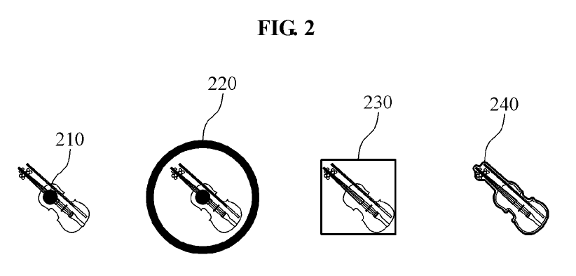

FIG. 2 illustrates an example of representing location information of an additional image object according to an example embodiment.

Referring to FIG. 2, an additional image object may be displayed on the display 110 using a variety of methods. Provided is a method of controlling a sound object to be synchronized, using an additional image object displayed on the display 110. Accordingly, a method capable of further easily identifying and selecting the additional image object displayed on the display 110 is to be provided.

For example, an additional image object may be represented using location information of a center point 210. Here, the user may select a corresponding additional image object by selecting the center point 210 of the additional image object displayed on the display 110 using the separate pointing device 150. The processor 120 may provide an interface for controlling a sound object synchronized with a selected additional image object through a separate popup window.

Also, the additional image object may be displayed by designating the center point 210 and a desired range 220 selectable by the user based on the center point 210 through the pointing device 150. The user may select the additional image object by selecting the additional image object displayed within the designated range 220 on the display 110 using the separate pointing device 150. The processor 120 may provide the interface for controlling the sound object synchronized with the selected additional object interface through the separate popup window.

Likewise, the additional image object may be displayed using a rectangular block 230 that includes an image of the additional image object or using a contour 240 of the additional image object. Without being limited to the above examples, the additional image object may be displayed on the display 110 using a variety of methods.

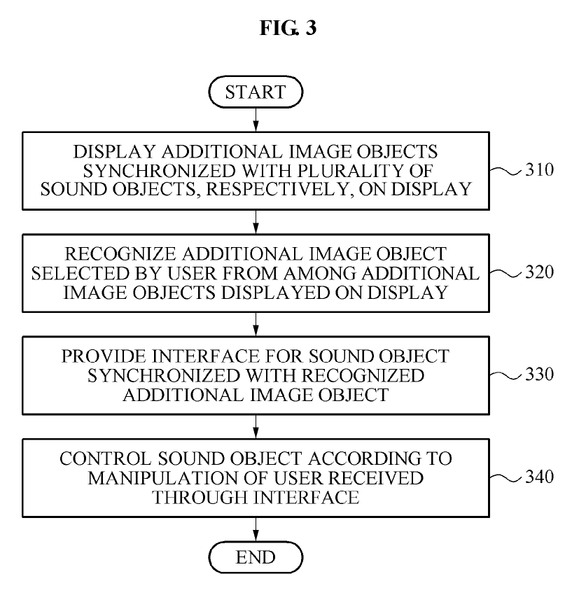

FIG. 3 is a flowchart illustrating a method of controlling a sound object according to an example embodiment.

In operation 310, the processor 120 may display additional image objects synchronized with a plurality of sound objects, respectively, on the display 110. In detail, the processor 120 may receive an audio signal to be played back on a specific space. Here, the received audio signal may be provided as a sound object with respect to each of a plurality of musical instruments. Each sound object may include metadata that includes playback location information of a corresponding sound object on the specific space, sound level information of the sound object, and display location information of an additional image object synchronized with the sound object on the display 110.

The processor 120 may play back each sound object based on playback location information and sound level information of a corresponding sound object included in metadata. Also, the processor 120 may display an additional image object synchronized with a sound object on the display 110 based on location information of the additional image object synchronized with the sound object on the display 110, so that the user may easily select the sound object.

Here, display location information of the additional image object synchronized with the sound object on the display 110 may be represented as coordinate information about an absolute horizontal pixel and an absolute vertical pixel of the display 110. Alternatively, display location information of the additional image object synchronized with the sound object on the display 110 may be represented as horizontal ratio information and vertical ratio information of a relative location of the image object synchronized with the sound object on the display 110 based on a horizontal size and a vertical size of the display 110.

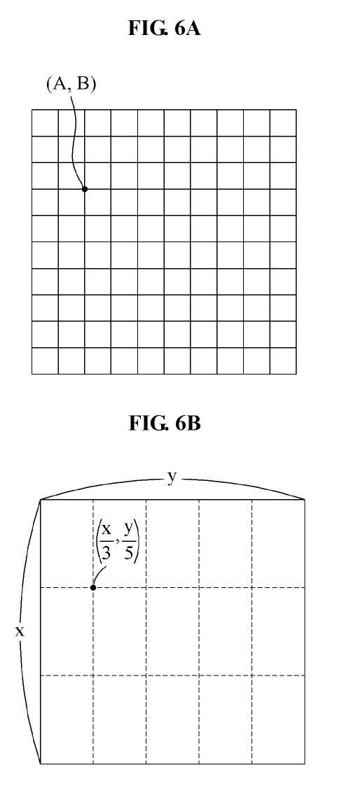

For example, referring to FIG. 6A, display location information of an additional image object synchronized with a sound object on the display 110 may be represented as coordinate information (A, B) about an absolute horizontal pixel and an absolute vertical pixel of the display 110. As described above, when representing the display location information of the additional image object on the display 110 based on the coordinate information about the absolute horizontal pixel and the absolute vertical pixel of the display 110, a resolution of the display 110 may be changed. Alternatively, when the horizontal size and the vertical size of the display 110 are changed, a location of the additional image object displayed on the display 110 may be changed.

Referring to FIG. 6B, when display location information of an additional image object synchronized with a sound object on the display 110 is represented as horizontal ratio information and vertical ratio information (x/3, y/5) of a relative point based on a horizontal size and a vertical size of the display 110, a resolution of the display 110 may be changed. Alternatively, although the horizontal size and the vertical size of the display 110 are changed, the additional image object may be displayed at the same location on the display 110.

In operation 320, the processor 120 may recognize an additional image object selected by the user from among the additional image objects displayed on the display 110. Here, the additional image object on the display 110 may be set to be a desired range selectable by the pointing device 150 of the user. If the user clicks using a mouse and the like or touches using a finger and the like the desired range corresponding to the additional image object, the processor 120 may recognize the clicked or touched additional image object.

In operation 330, the processor 120 may provide an interface for the sound object synchronized with the additional image object recognized in operation 320. Here, the processor 120 may provide information about the sound object synchronized with the recognized additional image object to the user through a separate popup window. Here, information about the sound object provided to the user through the popup window may include playback location information of the sound object on the specific space and sound level information of the sound object.

In operation 340, the processor 120 may control the sound object synchronized with the recognized additional image object based on manipulation information of the user received through the interface. In response to a change in a playback location and a sound level of the sound object synchronized with the recognized additional image object using the provided interface, for example, the popup window, the processor 120 may control the corresponding sound object to be played back based on the changed playback location and sound level of the sound object.

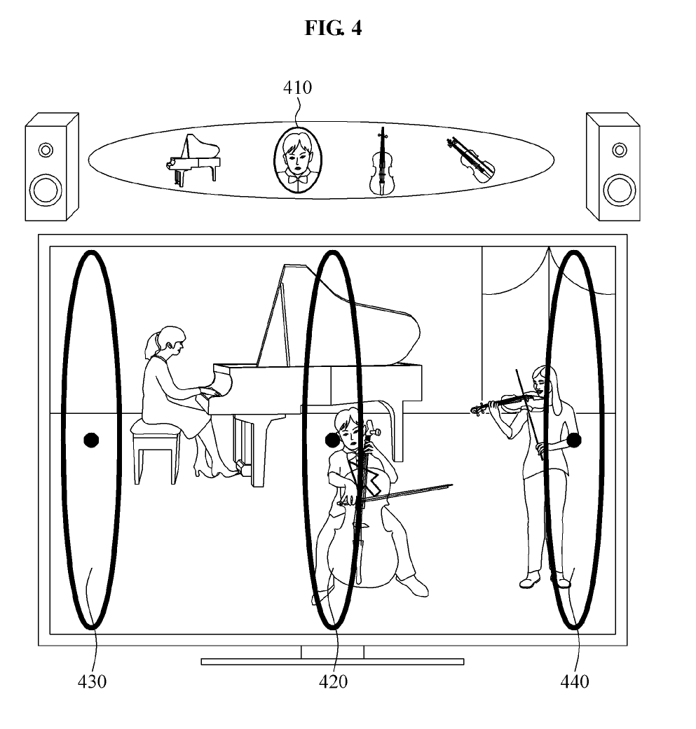

FIG. 4 illustrates an example of controlling a sound object having no synchronized image object among a plurality of sound objects according to an example embodiment.

A sound object having no synchronized additional image object may be present among a plurality of sound objects. For example, a separate commentary sound object 410 may be present in a sports broadcast program or a music broadcast program. Although the commentary sound object 410 is not represented on the display 110, the commentary sound object 410 may be played back through a speaker. However, since the commentary sound object 410 is not displayed on the display 110, a user may not directly select and control the commentary sound object 410.

Accordingly, the processor 120 may set a desired section on the display 110 as an additional image object for the sound object having synchronized image object. In an example in which the commentary sound object 410 is panned and played back at a center location of a specific space, the processor 120 may set a portion of the center of the display 110 as the additional image object 420 that is synchronized with the commentary sound object 410.

Accordingly, in response to a user selection on the additional image object 420 on the center of the display 110 using the pointing device 150, the commentary sound object 410 synchronized with the additional image object 420 may be selected.

Likewise, the processor 120 may control the sound object having no synchronized additional image object by setting a portion of the display 110 as an additional image object 430, 440 synchronized with the sound object based on a location at which the sound object having no synchronized additional image object is panned on the specific space.

The aforementioned control method may be applicable in an example in which a speaker is disposed not to interact with the display 110. For example, when the speaker is disposed to be relatively away from the display 110, the playback range of a sound signal through the speaker may become wide and be beyond the spatial synchronization between a sound and an image compared to the display 110. In this example, a playback area of a sound signal may be adjusted to be synchronized with a size of the display 110 regardless of a location of the speaker by controlling the additional image objects 430 and 440 of left and right channels assuming a channel signal as a sound object.

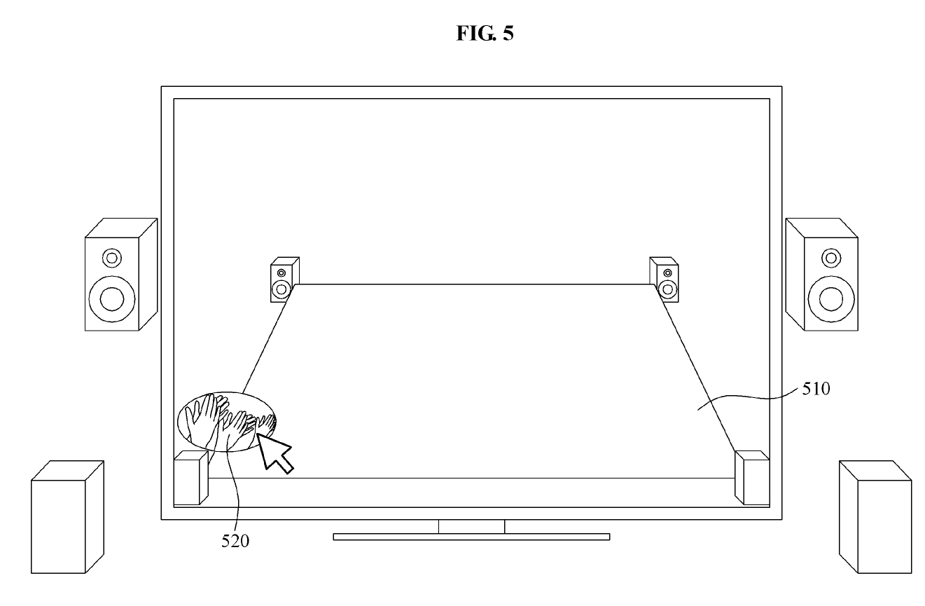

FIG. 5 illustrates another example of controlling a sound object having no synchronized image object among a plurality of sound objects according to an example embodiment.

When a sound object having no synchronized image object is present among a plurality of sound objects, the processor 120 may recognize a multichannel speaker disposed on a specific space. The processor 120 may set a virtual auditory space 510 that includes the recognized multichannel speaker and may display a virtual image object synchronized with a sound object having no synchronized image object among the plurality of sound objects on the set virtual auditory space 510.

In an example in which a multichannel speaker equipped with a surround channel is disposed on the specific space, a sound object being played back through a speaker may be present although the sound object, such as applause 520 in a concert is not displayed on the display 110. In this example, the processor 120 may display an additional image object synchronized with the sound object, such as the applause 520, on the virtual auditory space 510 based on a location at which the sound object, such as the applause, is panned on the specific space.

Here, in response to a user selection on the additional image object displayed on the virtual auditory space 510, the processor 120 may provide an interface for the selected additional image object and may control the sound object, such as the applause 520, synchronized with the selected additional image object according to a manipulation of the user.

As described above, the sound object control method according to example embodiments may provide a conversation type service that enables a user to select and control a sound object provided as an object together with metadata. That is, according to example embodiments, since an image object synchronized with a sound object is displayed on a display, the user may intuitively control the image object and a conversation type service associated with object-based sound may be easily provided.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling a sound object, the method comprising:
displaying image objects on a display; and
controlling a sound object corresponding to an image object selected by a user from among the image objects displayed on the display, the sound object being synchronized with the selected image object,
wherein the sound object synchronized with the selected image object includes metadata that includes any one or combination of playback location information of the sound object on a specific space, sound level information of the sound object, and display location information of the selected image object synchronized with the sound object on the display.

2. The method of claim 1, wherein the controlled sound object is among a plurality of sound objects, and
the displaying comprises setting a desired area on the display for an image object, among the image objects, corresponding to a sound object having no synchronized image object, in response to a presence of the sound object having no synchronized image object among the plurality of sound objects.

3. The method of claim 1, wherein the controlled sound object is among a plurality of sound objects, and the displaying comprises:
recognizing a multichannel speaker having a surround channel disposed on the specific space, in response to a presence of a sound object having no synchronized image object among the plurality of sound objects;
setting a virtual auditory space that includes the recognized multichannel speaker; and
displaying a virtual image object synchronized with the sound object having no synchronized image object among the plurality of sound objects on the set virtual auditory space.

4. The method of claim 1, wherein the selected image object is set to be in a desired range selectable by a pointing device of the user.

5. The method of claim 4, wherein the controlling comprises:
providing an interface for the controlling of the sound object synchronized with the selected image object, in response to a selection on the desired range by the pointing device of the user; and
controlling a location at which the sound object synchronized with the selected image object is to be played back on the specific space and a sound level of the sound object synchronized with the selected image object, according to a manipulation of the user received through the provided interface.

6. The method of claim 1, wherein the display location information of the selected image object is represented as coordinate information about an absolute horizontal pixel and an absolute vertical pixel of the display.

7. The method of claim 1, wherein the display location information of the selected image object is represented as horizontal ratio information and vertical ratio information of a relative location of the selected image object based on a horizontal size and a vertical size of the display.

8. An apparatus for controlling a sound object, the apparatus comprising:
a display configured to display image objects; and
a processor configured to control a sound object corresponding to an image object selected by a user from among the image objects displayed on the display, the sound object being synchronized with the selected image object,
wherein the sound object synchronized with the selected image object includes metadata that includes any one or combination of playback location information of the sound object on a specific space, sound level information of the sound object, and display location information of the selected image object synchronized with the sound object on the display.

9. The apparatus of claim 8, wherein the controlled sound object is among a plurality of sound objects, and
the processor is further configured to set a desired area on the display for an image object, among the image objects, corresponding to a sound object having no synchronized image object, in response to a presence of the sound object having no synchronized image object among the plurality of sound objects.

10. The apparatus of claim 8, wherein the controlled sound object is among a plurality of sound objects, and
the processor is further configured to recognize a multichannel speaker having a surround channel disposed on the specific space, in response to a presence of a sound object having no synchronized image object among the plurality of sound objects, to set a virtual auditory space that includes the recognized multichannel speaker, and to display a virtual image object synchronized with the sound object having no synchronized image object among the plurality of sound objects on the set virtual auditory space.

11. The apparatus of claim 8, wherein the selected image object is set to be a desire range selectable by a pointing device of the user.

12. The apparatus of claim 8, wherein the processor is further configured to provide an interface for controlling the sound object synchronized with the selected image object, in response to a selection on an image object to be synchronized with each of the plurality of sound objects by the pointing device of the user, and to control a location at which the sound object synchronized with the selected image object is to be played back on the specific space and a sound level of the sound object synchronized with the selected image object, according to a manipulation of the user received through the provided interface.

13. The apparatus of claim 8, wherein the display location information of the selected image object is represented as coordinate information about an absolute horizontal pixel and an absolute vertical pixel of the display.

14. The apparatus of claim 8, wherein the display location information of the selected image object is represented as horizontal ratio information and vertical ratio information of a relative location of the selected image object based on a horizontal size and a vertical size of the display.
